(19) United States
(12) Patent Application Publication
(10) Pub. No.: US 2006/0253415 A1
(43) Pub. Date: Nov. 9, 2006

(54) Data-defined communication device

(76) Inventors: Sayan Chakraborty, Niwot, CO (US); Sean T. Loving, Lafayette, CO (US)

Correspondence Address: LATHROP & GAGE LC, 4845 PEARL EAST CIRCLE, SUITE 300, BOULDER, CO, 80301, US

(21) Appl. No.: 11/328,209

(22) Filed: Jan. 9, 2006

Related U.S. Application Data
(60) Provisional application No. 60/673,692, filed on Apr. 21, 2005.
(60) Provisional application No. 60/712,957, filed on Aug. 31, 2005.

(51) Int. Cl. G06F 17/30

(52) U.S. Cl. 707/1

(57) ABSTRACT

A system and method for defining one or more operating characteristics of a communication device with data is disclosed. In one embodiment, the communication device includes an input port configured to receive a data file that includes information that defines at least one communication protocol for the communication device, and the communication device includes a data file interpreter configured to alter operation of a radio in the communication device in accordance with the at least one communication protocol. In variations, the communication device includes an RFID tag reader coupled to the radio portion, and the tag reader segment is configured to read tag-data received via the radio. In these variations, the data file interpreter is configured to alter operation of the RFID tag reader in accordance with information in the data file, which defines, at least in part, a syntax for RFID reader commands.

### RELATED APPLICATIONS

The present application claims benefit of priority to commonly owned and assigned U.S. Provisional Application Nos. 60/673,692, filed 21 Apr. 2005, and 60/712,957, filed 31 Aug. 2005, and from U.S. application Ser. No. 11/301,396, filed 13 Dec. 2005; Ser. No. 11/301,423 filed 13 Dec. 2005; Ser. No. 11/301,587, filed 13 Dec. 2005; Ser. No. 11/301,770, filed 13 Dec. 2005; Ser. No. 11/323,214 filed 30 Dec. 2005; Ser. No. 11/328,209, filed 09 Jan. 2006; Ser. No. 11/387,421 filed 23 Mar. 2006, and Ser. No. 11/387,422 filed 23 Mar. 2006. Each of the aforementioned applications is incorporated herein by reference.

### BACKGROUND

1. Field of the Invention

The present invention relates to communications systems. In particular, but not by way of limitation, the present invention relates to systems and methods for communicating with tag identifiers.

2. Description of the Related Art

Software Defined Radio (SDR) technology is well known. U.S. Pat. No. 6,052,600 “Software programmable radio and method for configuring” to Fette, et al ., for example, adds to the teachings disclosed at or before the 1998 Modular Multifunction Information Transfer System (MMITS) Forum on Software Defined Radio.

One major advantage of SDR technology is the ability to update new software algorithms to support new radio protocols, given a fixed hardware platform; however, several disadvantages remain with SDR technology. One main disadvantage is that one skilled in the art of software is required to author each new algorithm. Another main disadvantage is that to adequately support various software processing algorithms, the signal processing part of the hardware platform requires significant size, complexity and power.

Although present devices are functional, they are burdensome, inefficient or otherwise unsatisfactory. Accordingly, a system and method are needed to address the shortfalls of present technology and to provide other new and innovative features.

### SUMMARY

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In one embodiments a method for operating a radio includes receiving a data file, which includes information that defines at least one communication protocol for the radio, and reading the data file so as to access the information. The radio is then altered in accordance with the information so as to enable the radio to operate in accordance with the at least one communication protocol.

In another embodiments a wireless communication device includes information that defines at least one communication protocol for the communication device. The communication device also includes a radio configured to transmit and receive signals and a data file interpreter configured to alter operation of the radio in accordance with the at least one communication protocol. In variations, the communication device includes an RFID tag reader coupled to the radio. The tag reader is configured to read tag data received via the radio, and the data file interpreter is configured to alter operation of the RFID tag reader in accordance with information in the data file, which defines, at least in part, a syntax for RFID reader commands.

In yet another embodiment, a data structure for a portable data file is configured to organize information, which defines at least one protocol for a communication device, and the data structure includes a physical layer segment configured to include data to define physical layer communication characteristics of the communication device and a medium access control (MAC) segment configured to include data to define MAC layer communication characteristics of the communication device.

In another embodiment, a method for altering operations of a communication device to facilitate communications between the communication device and a transceiver comprises the following steps: attempting to communicate with the transceiver, determining that the transceiver communicates via an unknown protocol, retrieving data defining a first protocol, and attempting to communicate with the transceiver in compliance with the first protocol.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a block diagram of an embodiment of a system for defining operations of a communication device with data.

FIG. 2 is a block diagram depicting one embodiment of the tag reader of FIG. 1.

FIG. 3 is a block diagram depicting another embodiment of the tag reader of FIG. 1.

FIG. 4 is a block diagram depicting one embodiment of the data-file interpreter of FIG. 1.

FIG. 5 is a block diagram depicting an embodiment of a software architecture such as may be utilized in connection with the communication devices depicted in FIGS. 1, 3 and 4.

FIG. 6 is a block diagram depicting an exemplary platform and exemplary libraries and drivers organized in accordance with the software architecture depicted in FIG. 5.

FIG. 7 is a block diagram depicting an exemplary embodiment of the tag reader of FIG. 1 organized in accordance with the software architecture depicted in FIG. 5.

FIG. 8 is a block diagram depicting another embodiment of the communication device of FIG. 1 that is organized in accordance with the software architecture of FIG. 5.

FIG. 9 is a block diagram depicting yet another embodiment of a system for defining one or more aspects of a communication device with data.

FIG. 10 is a flowchart depicting a method for defining one or more operating aspects of a communication device with data.

FIG. 11 depicts one embodiment of a data structure for the data files of FIG. 1.

FIG. 12 depicts exemplary aspects of a signal that are definable in accordance with one embodiment.

FIG. 13 depicts another embodiment of a data structure for the data files of FIG. 1.

FIG. 14 is a block diagram depicting a system for generating and validating data files in accordance with an exemplary embodiment.

FIG. 15 is a flowchart depicting a method in accordance with an exemplary embodiment of the present invention.

### DETAILED DESCRIPTION

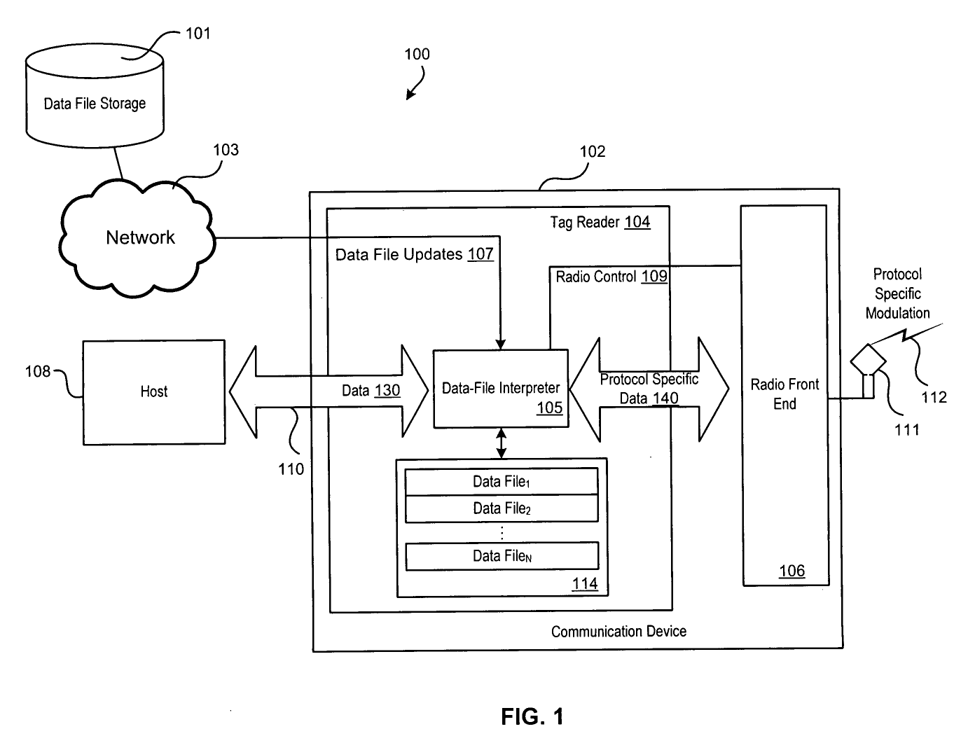

Referring now to the drawings, where like or similar elements are designated with identical reference numerals throughout the several views, FIG. 1 is a block diagram depicting an exemplary system 100 for defining, with definition data, operational characteristics of a data-definable communication device 102.

As discussed further herein, the data-definable communication device 102, (also referred to herein as a data defined radio (DDR) 102) provides many of the benefits of software-defined radio (SDR) technology while eliminating (or substantially reducing) the need for programmers or other personnel skilled in the art of software. Moreover, the data-defined communication device 102 enables the complexity of the signal processor to be reduced by exchanging the software support requirements of SDR (e.g., lots of silicon) for the data support requirements of DDR (e.g., relatively little silicon). Furthermore, one of ordinary skill in the art having the benefit of the teachings disclosed herein will appreciate that data-defined technology is extendable beyond radios to electronic devices generally and to the functions they perform. For example, and as described further herein, data defined RFID readers (DDRRs) are advantageous over software defined RFID readers (SDRRs).

As depicted in the exemplary embodiment, the system 100 includes the communication device 102, which is coupled to a data file database 101 via a network (e.g., the Internet) 103. As shown, the communication device 102 in the exemplary embodiment includes an RFID tag reader 104 coupled to a radio front-end 106, which is shown transmitting a signal 112 via an antenna 111. As depicted, the tag reader 104 includes a data file interpreter 105 and a memory module 114, which is configured to store N data files. In addition, the tag reader 104 is in communication with a host 108 via a host communication link 110.

In some embodiments, the host 108 is a general purpose computer or server adapted with software to enable the host 108 to communicate with the tag reader 104. In other embodiments the host 108 is a processor that is embedded in another device (e.g., the communication device 102) and is configured to execute instructions enabling the host 108 to communicate with the tag reader 104.

The communication link 110 may be a communication link that operates in accordance with one or more protocols (e.g., Ethernet, USB, 802.11, ZigBee, RS-232, Bluetooth, TTL, SPI, MMC, SDIO, CF and I²C) or other protocols developed in the future. In other embodiments, the communication device 102 communicates with the host 108 via the network 103.

The communication device 102 in some embodiments is a device that functions primarily to read tags, and in other embodiments the communication device 102 is a device that has other functions. For example, the communication device 102 may be any one of a variety of consumer electronics devices (e.g., a computer printer, DVD player, personal digital assistant (PDA) or radio handset (e.g., cellular telephone)), and it should be recognized that in other embodiments discussed further herein, the communication device 102 does not include a tag reader 104.

In some embodiments, functions of the tag reader 104 and data file interpreter 105 are realized by a processor, a computer readable medium (e.g., volatile memory and/or non-volatile memory) and instructions encoded in the computer readable medium. As discussed further herein, in these embodiments the tag reader 104 and data file interpreter 105 may utilize a processor of the communication device 102 (e.g., a control processor or radio processor) or the tag reader 104 and the data file interpreter 105 may utilize a separate application processor.

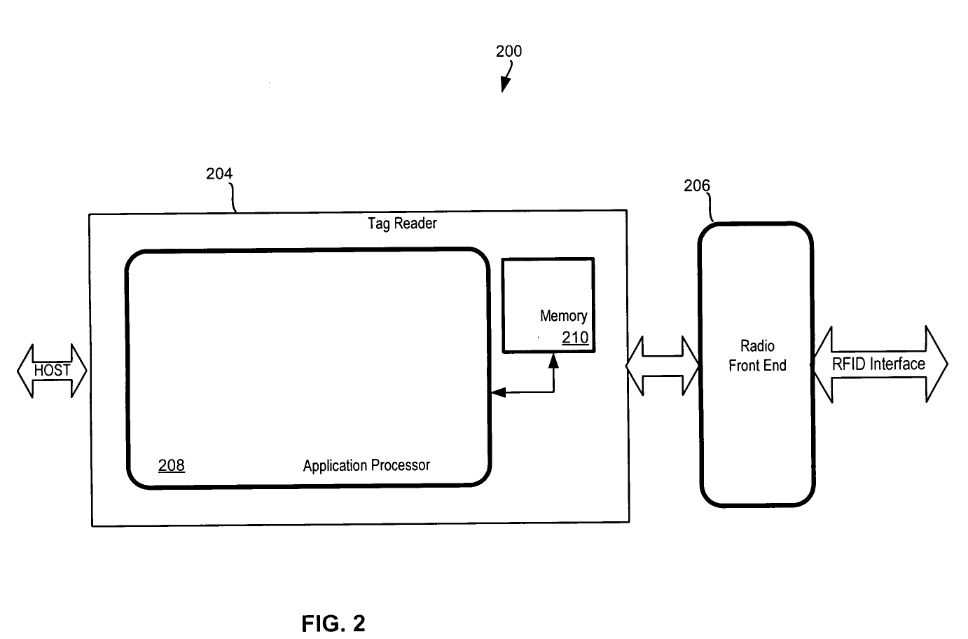

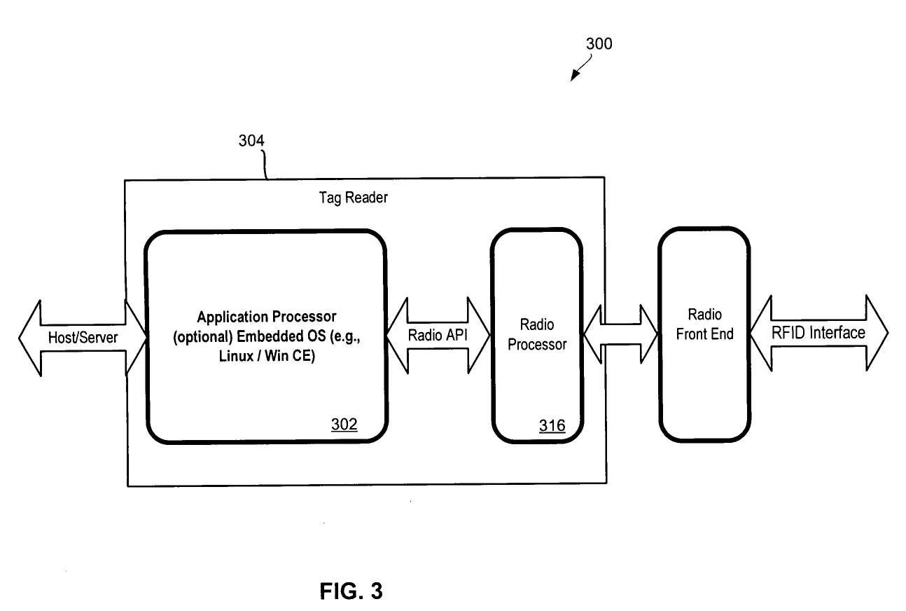

Referring briefly to FIGS. 2 and 3, for example, shown are block diagrams 200, 300 of two embodiments of the tag reader 104 depicted in FIG. 1. As shown, FIG. 2, depicts a tag reader 204 realized with an application processor 208 configured to execute instructions from memory 210 (e.g., non-volatile memory). Tag reader 204 is also shown communicating with a radio front end 206. FIG. 3 depicts a block diagram 300, which depicts a tag reader 304 realized by an application processor 302 and a radio processor 316 that execute instructions from memory (not shown). It is also contemplated that in other embodiments the tag reader 304 may be realized by the radio processor 316 in connection with instructions stored in memory. In addition, functions associated with tag reading and the data file interpreter 105 may be distributed among an application processor (e.g., application processor 302) and a radio processor (e.g., the radio processor 316).

One of ordinary skill in the art will recognize that the application and radio processors 208, 302, 316 may be realized by a variety of devices including processors sold under the brand names of PIC, AVR, ARM, PowerPC and Xscale. In yet other embodiments, the tag reader 104 and data file interpreter 105 are implemented by hardware or a combination of hardware and software. It is contemplated, for example, that the tag reader 104 and/or the data file interpreter 105 may be realized, at least in part, by one or more of a variety of devices including field-programmable gate arrays (FPGAs), complex programmable logic devices (CPLDs), programmable logic devices (PLDs), application-specific integrated circuits (ASICs) and/or other discrete analog and/or digital components.

Although the communication device 102 in the exemplary embodiment is a tag reader enabled device (i.e., by virtue of the tag reader 104), this is certainly not required, and in other embodiments, the data file interpreter 105 is implemented in communication devices that are unassociated with tag readers. In these embodiments, the functions carried out by the data file interpreter 105 may be carried out by similar hardware and or software that is described as effectuating the tag reader 104.

Referring again to FIG. 1, the radio front-end 106 in several embodiments is realized by analog radio components (e.g., analog transmit chain and/or receiver chain) and may be realized, for example, as a UHF or an HF radio. One of ordinary skill in the art will appreciate that there are a variety of radio front-ends that are available with varying levels of complexity. Generally, the more powerful the radio front-end 106 is (e.g., in terms of modulating/demodulating and decoding signals from tags), the less powerful the signal processing in the tag reader 104 needs to be. Some exemplary radio front-ends include radios sold under brand names including Atmel, Inside Contactless, EM, Melexis, Philips, Skyetek, WJ and Texas Instruments.

In operation, the communication device 102 in the present embodiment receives, via the network 103, one or more data files 107 from the data file database 101 and stores the data file(s) 107 in the memory module 114 of the communication device 102. The data file interpreter 105 then utilizes data in the data file(s) to alter one or more aspects of the operation of the communication device 102.

In many embodiments for example, each of the N data files stored on the communication device 102 defines, with data, physical layer and/or medium access control (MAC) layer protocols to be utilized by the communication device 102. As depicted in FIG. 1 for example, data 130 that is intended to be transmitted as the signal 112 by the communication device 102 is reorganized by the data file interpreter 105, in accordance with a MAC layer protocol defined by a data file and then transmitted as the signal 112 in accordance with a physical layer protocol also defined by the data file.

As depicted in the exemplary embodiment, the data file interpreter 105 is in communication with the radio front end 106 via a radio control link 109, which enables any changes to radio-specific operating characteristics to be communicated to the radio front end 106. It should be recognized that the radio control link 109 is depicted as a separate discrete communication link merely for convenience and that the radio control link 109 may be realized by hardware or software in connection with hardware. Moreover, the radio control link 109 may communicate with the radio front end 106 via the same communication path as the protocol specific data 140.

In addition, many other features of the communication device 102 may be data-defined instead of being defined by specific software code. For example, and without limitation, operating speeds and power consumption, modulation schemes, regulatory performance and other operating characteristics (many of which are discussed further herein) may be defined by data. As an additional example, each of the N data files depicted in FIG. 1 may define a command syntax that is utilized by the tag reader 104. Although the communication device 102 in the exemplary embodiment is depicted as storing data files, in other embodiments, the communication device 102 is adapted to retrieve (e.g., upon startup) a data file from a remote source (e.g., the data file storage 101).

As a consequence, the system 100 enables the communication device 102 to be easily adapted to operate in accordance with customized protocols and/or to operate with specific configurations without having to write new software code to effectuate the protocols and/or desired configurations. In several embodiments discussed further herein for example, the data file interpreter 105 is realized by generic software and/or hardware that interprets the data files and effectuates the defined behavior accordingly.

In some embodiments, data files are provided to the communication device 102 as part of an update service available to the communication device 102. In someembodiments for example, the data file storage 101 is accessible by an update server and the communication device accesses the update server periodically and/or in response to a particular event to check for any updated data files that are applicable to the communication device 102.

In yet other variations, the system 100 is configured to enable data files to propagate to the communication device 102 via email and the communication device 102 and/or the host 108 is adapted so as to be capable of parsing the email so as to retrieve the data file. Moreover, the communication device 102 in some of these variations is configured to send an email to request any updated data files, or to inform an administrator of any events or conditions that require attention, or to report events or conditions to other (e.g. web) services. The communication device 102 may send and receive emails indirectly via the host 108.

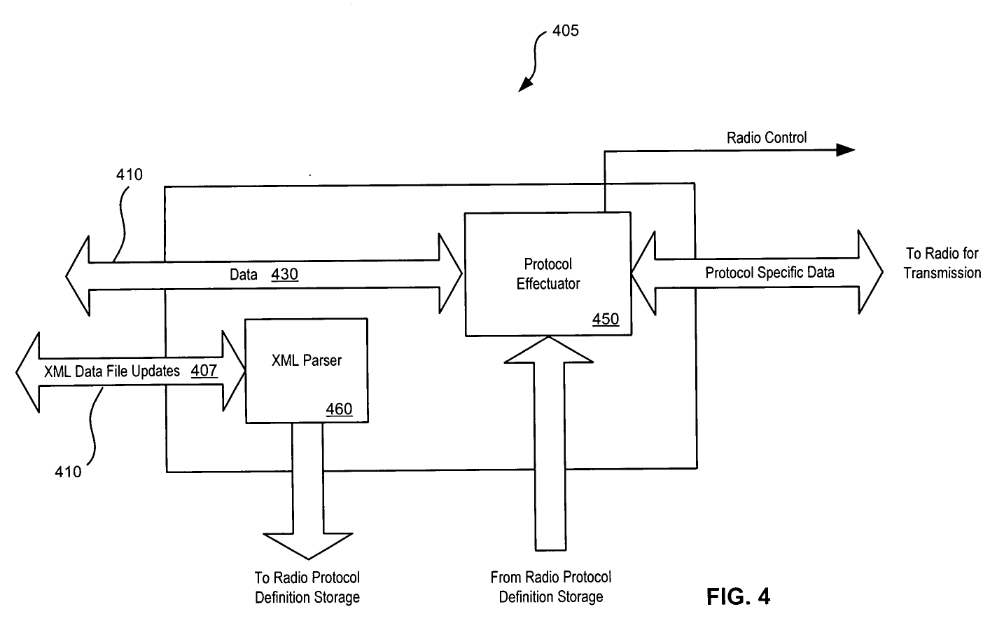

Referring next to FIG. 4, shown is one embodiment of the data file interpreter 105 depicted in FIG. 1. As shown, the data file interpreter 405 in this embodiment includes an XML parser 460, which is configured to receive and convert XML data files 407 into binary data files that are then stored in memory (e.g., the memory 114). In addition, the data file interpreter 405 includes a protocol effectuator 450 that is configured to receive the stored, binary protocol-definition files and effectuate the protocol(s) defined by the data therein. Beneficially, the present embodiment enables data files to be generated in accordance with a user-friendly XML format, which is then automatically converted to a binary format that may be stored (e.g., in the memory 114) and retrieved later by the protocol effectuator 450. Although the data 430 that is received by the data file interpreter 405 and the XML data files 407 that are received by the XML parser 460 are depicted as two separate data paths, in some embodiments the data 430 and XML data files 407 are communicated to data file interpreter 405 via the same communication channel 410.

The XML parser 460 and the protocol effectuator 450 may be realized by software and/or hardware. In one embodiment for example, the XML parser is realized by software executed by the application processor 208, 302 and the protocol effectuator 450 may be realized by code executed by the radio processor 316, but this is certainly not required.

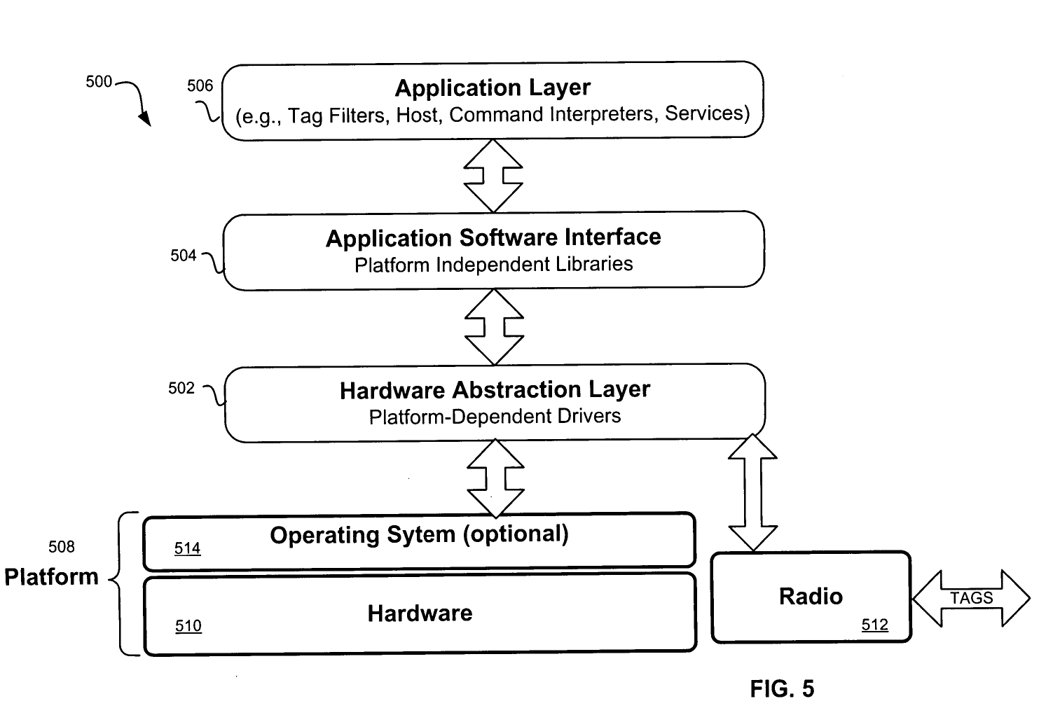

Referring next to FIG. 5, shown is a block diagram 500 depicting a software architecture utilized in connection with the data-definable communication device 102 in accordance with several embodiments. As shown, the architecture includes three components: a hardware abstraction layer 502, an application software interface 504 and an application layer 506. Also shown is a platform 508 that includes hardware 510 that underlies the communication device 102.

Also shown is an optional operating system 514, which may be realized by a variety of operating systems including operating systems sold under the trade names of Linux, WinCE, Symbian, and VxWorks.

The hardware abstraction layer 502 in this embodiment includes platform-dependent drivers that effectuate low-level functions to carry out alterations of the communication device that are made in accordance with specific protocols (e.g., MAC, physical layer and/or command syntax) and/or other operational characteristics defined by data in data files. In the exemplary embodiment, the drivers are optimized for the hardware 510, radio 512 and the operating system 514.

The application software interface 504 includes platform-independent libraries that provide, via a common API, many of the functions associated with effectuating the specific protocols and/or other operational characteristics defined by data in the data files (e.g., the N data files depicted in FIG. 1). In addition, when the communication device 102 is enabled with RFID tag reading capability, the software application interface 504 may provide many of the functions associated with reading RFID tags. Advantageously, the library functions are portable across reader platforms because they are independent of embedded processors, operating systems, host interfaces and radios that reside at the platform level 508 of the exemplary architecture.

The application layer 506 in this embodiment is utilized to define the functionality of the data file interpreter 105, 405, the XML parser 460 and the tag reader 104. As discussed further herein, applications of the application layer 506 may reside with the host 108, the communication device 102 or may be distributed among the host 108 and the communication device 102. To carry out desired functions, application code in the application layer 506 makes calls to the lower level library and driver functions.

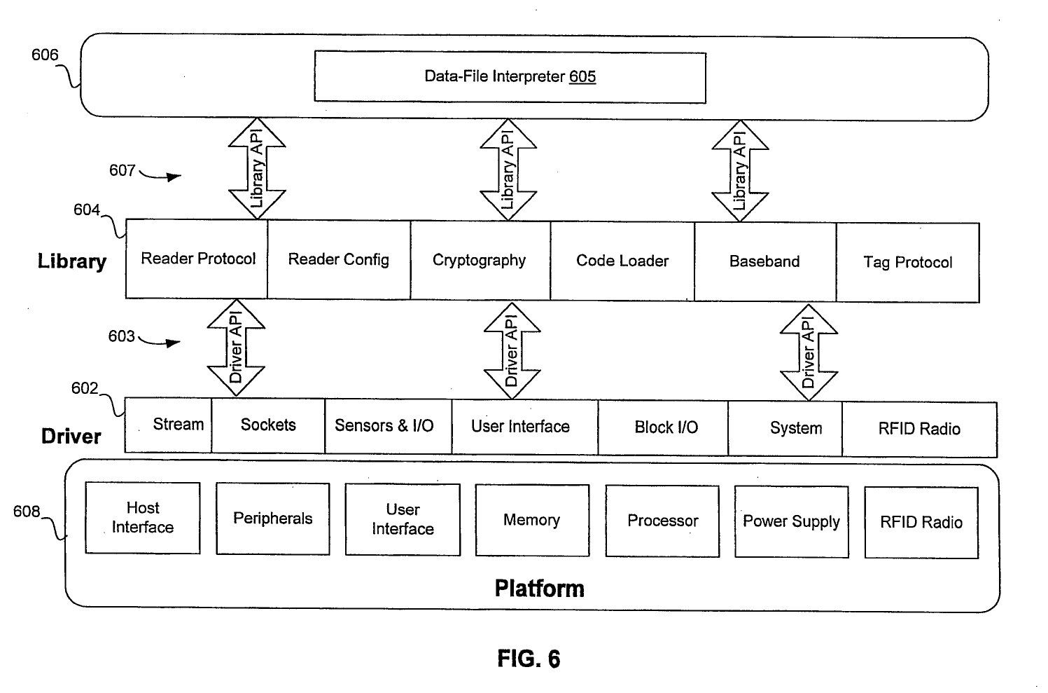

Referring next to FIG. 6, shown is a block diagram depicting an exemplary embodiment of a data file interpreter 605, which may be implemented as the data file interpreter 105 depicted in FIG. 1. In this embodiment, the data file interpreter 605 is realized by application code 606 in connection with exemplary drivers 602 and exemplary libraries 604 in accordance with the software architecture depicted in FIG. 5. In this embodiment, the data file interpreter 605 utilizes one or more of the libraries 604 and drivers 602 to effectuate the specific protocols and/or other operational characteristics of the communication device 102. In particular, the data file interpreter 605 in the present embodiment utilizes the functions carried out by the libraries 604 and drivers 602 (described below) to effectuate the protocol(s) and/or other operational characteristics of the communication device that are defined by data in one or more of the N data files.

The platform 608 in this embodiment includes a host interface, peripherals, a user interface, memory, a processor, power supply and a radio. It should be recognized that this is only exemplary of the type of hardware that may be part of a platform. In an alternative embodiment for example, the platform 608 may have an operating system, and in another embodiment the platform 608 may not have a user interface.

The drivers 602 in this embodiment provide interface handling for the hardware of the platform 608. Advantageously, the driver API 603 to the drivers 602 is portable and platform independent while the driver functions 602 are dependent upon the platform 608. As a consequence, a developer need only learn the API calls 603 to the drivers 602 in order to create code that is applicable across a variety of platforms. As shown, the drivers in this embodiment include stream drivers, sockets drivers, sensors and I/O drivers, user interface drivers, block I/O drivers, system drivers and radio drivers.

The stream drivers are functions that provide hardware interface handling for communication with a host (e.g., the host 108) or other peripheral devices. For example, stream drivers may include drivers for TTL, I²C, SPI, USB and RS-232. Beneficially, a collection of stream drivers may be stored on a communication device (e.g., the communication device 102) to enable the communication device 102 to communicate with a variety of host interfaces.

The socket drivers are functions that enable task management, port sharing among multiple applications and networking management functionality. Some examples of socket drivers include Ethernet, Wi-Fi, Zigbee, Bluetooth, etc.

The sensor and I/O drivers are functions that provide hardware interface handling for communication with sensors and other I/O devices that are connected to the hardware of the platform 608. For example, sensor drivers may include drivers for temperature sensors, current sensors and voltage sensors and the I/O drivers may include drivers for general purpose I/O (GPIO).

The user interface drivers are functions that provide hardware interface handling for communication with the user interface of the platform 608. For example, the user interface driver may include drivers for touch screen hardware, pointing devices, biometric security devices and keyboards.

Block I/O drivers are functions that enable communications with memory and other platform resources (e.g., hard drives, busses, ROM, RAM, EEPROM, etc.).

The system drivers include drivers that provide an interface to various system components of the platform hardware. For example, the system drivers may include drivers for timers, power management and interrupts of the platform hardware.

The radio drivers include drivers that provide an interface to a variety of radio types (e.g., analog front ends (AFEs)) so as to enable communications with a variety of radios with a platform independent API 603. In addition, the radio drivers in this embodiment enable data-defined aspects of operation at the physical layer to be effectuated. For example, the data file interpreter 605 may interpret data in a data file and utilize the drivers to carry out transmission and reception of signals in accordance with a physical layer protocol defined by data in the data file. Moreover, if a user desires to upgrade the radio front end 106 of the communication device 102, the user need only change radio drivers to the radio driver of the new radio.

As shown, the library 604 in this embodiment is accessible by the data file interpreter 605 via a portable and platform-independent API 607 so as to be applicable across a variety of processor and radios. As depicted, the library 604 includes a reader protocol library, reader configuration library, a cryptography library, a code loader library, an RFID baseband library and a tag protocol library.

The reader protocol library in the exemplary embodiment includes functions that implement many low-level operations performed by typical host communication protocols. For example, the reader protocol library may include a cyclical redundancy code (CRC) library, a parity calculation library, forward error correction algorithms, message data parsers, ASCII to hexadecimal encoders and decoders, host-protocol command interpreters, host-protocol command executors and host-protocol error handlers.

It should be recognized that a reader-side implementation of a host-to-reader communication protocol may reside in the reader protocol library, the application code area 606 or both. For example, an open-source application marketed under the trade name of SkyeTek Protocol Command Interpreter (SPCI) resides within the application code area 606 and makes calls to the functions in the reader protocol library as well as other libraries and the drivers 602.

The configuration library includes functions that enable applications, including the data file interpreter 605, within the application code area 606 to control the inner workings of the communication device 102. For example, the data file interpreter 605 may establish, based upon data in a data file, default values and runtime values, modes of operation, performance tradeoff algorithms and other aspects of the communication device 102 with the configuration libraries. In addition, schedule, event, interrupt and priority handlers may also be altered by the data file interpreter 605 by using the configuration libraries.

The cryptography library in this embodiment handles the security and cryptographic data processing that may be required relative to many aspects of the communication device 102. For example, the cryptography library may include tag-reader cryptography, reader-host cryptography, user data security, network data security and hardware security management.

A variety of cryptographic techniques may be utilized including private key algorithms and propriety security algorithms (e.g., security algorithms marketed under the trade names of Philips, Mifare, Inside Contactless, Pico Pass, Infineon, My-d, Atmel, CryptoRF, etc.). In addition, public key algorithms may be utilized including PGP and commonly known algorithms such as DES, 3-DES and RSA, for example.

The tag protocol library in this embodiment defines one or more of the air interface; initialization and anti-collision procedures; and the data transmission method utilized for the forward and return links. The air interface describes characteristics of baseband radio functionality and RF symbol definitions, which define how data bits are sent and received through the air via the RFID interface.

The initialization and anti-collision procedures describe how a tag reader and a tag interact to communicate unique or repeated tag identification numbers from tag(s) to the reader. The data transmission method that is defined by the tag protocol library describes how the forward and return link messages are constructed, encoded and recoded to perform basic RFID transactions including, for example, identifying, reading and writing RFID tags.

In some variations, the tag protocol library is segregated into three general classes of functions: agnostic functions, which provide the highest level of abstraction so that applications operating in the application code area 606 may operate independent of tag types that the tag reader 104 may experience; protocol functions, which allow applications to utilize a particular tag type without concern for tag manufacturer-specific implementations; and manufacturer functions, which enable applications to access the manufacturer-specific features of a standards-based tag and utilize proprietary tag protocols from independent tag manufacturers.

In the context of high frequency (HF) air interfaces (e.g., 13.56 MHz), the tag protocol library may support a variety of protocols including, but certainly not limited to, ISO15693-2, ISO18000, ISO14443-2 Type A, ISO14443-2 Type B, Phillips ICode SL1, Texas Instruments Tag-it HF and TagSys C210, C220 and future protocols. With respect to ultra high frequency (UHF) air interfaces (e.g., 860-960 MHz), the tag protocol library may support protocols including, but not limited to, ISO18000-6A, ISO18000-6B, EPC Class 0/0+, EPC Class 1, EPC Class 1 Gen 2, and other protocols yet to be developed.

The baseband library in the exemplary embodiment includes baseband functions that are portable across disparate hardware chips, processors and operating systems (if present). The baseband functions handle low-level interaction between the tag protocol library and the platform-dependent radio drivers. In addition, the baseband functions digitally define the RF characteristics of individual bit symbols and presents the defined symbol definitions to the low-level, protocol specific, RFID radio drivers so as to enable the tag protocol library functions to see only binary code (i.e., ones and zeros).

The code loader library in the exemplary embodiment includes functions that facilitate the loading of new code and/or data. For example, the code loader includes functions to load programs into the application code area 606, functions to load new drivers to the set of drivers 602, functions to load new configuration data or default values for the tag reader 104 and functions to add new functions to the libraries 604.

As an example of the functionality of the code loader library, if a developer is assisting a customer that is seeking a new technology, and the technology requires the addition of a new radio circuit to accommodate a specialty RFID radio tag and protocol, when the new radio is added, the developer simply adds a new radio driver to the set of drivers 602 and adds the required symbol definitions and handling functions to the RFID baseband and tag protocol libraries, respectively. The developer is then able to write application specific programs (e.g., that reside on the communication device 102 and/or the host 108), which make function calls to the newly added functions that control the new radio hardware and handle the new tag protocol.

It should be recognized that the specific hardware, drivers, libraries and applications described with reference to FIG. 6 are exemplary only and that certain functions may be omitted, combined or enhanced without departing from the scope of the present invention.

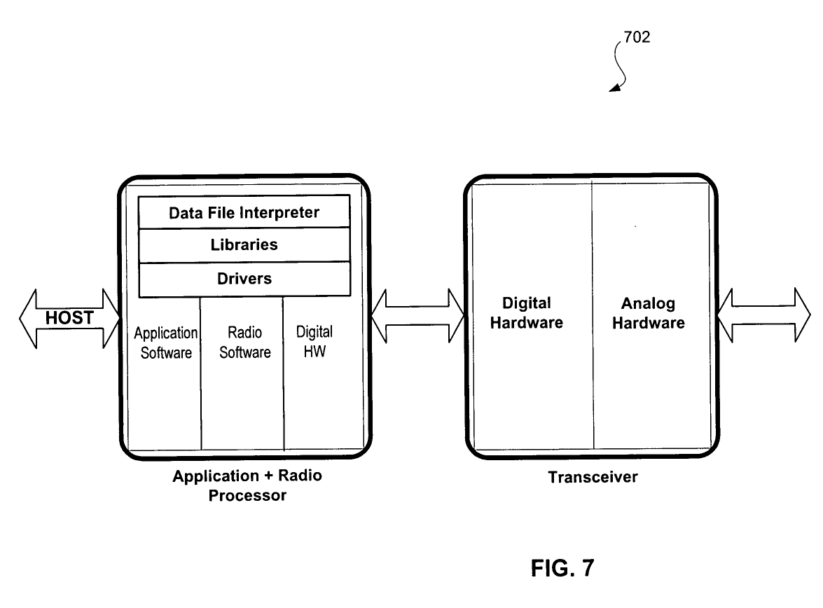

Referring to FIG. 7, shown is a block diagram of an exemplary communication device 702, such as may be implemented for the communication device 102 depicted in FIG. 1. As shown, the data file interpreter in this embodiment is realized by both an application processor and a radio processor, which execute software that is organized in accordance with the software architecture described with reference to FIGS. 5 and 6. As shown, the communication device 702 in this embodiment includes application software, radio software and digital hardware. The data file interpreter in this embodiment resides in an application code area (e.g., the application code area 606), which utilizes a library API (e.g., the library 607) and a driver API (e.g., driver API 603) to carry out its intended function.

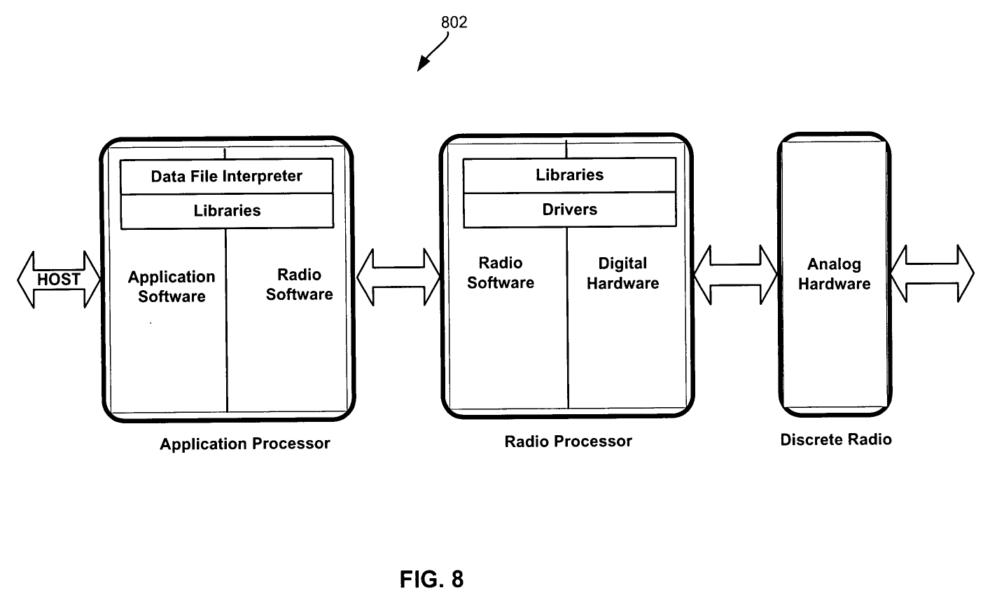

Referring next to FIG. 8, shown is a block diagram of another communication device 802, which may be implemented for the communication device depicted in FIG. 1. As shown, the data file interpreter in the present embodiment is realized by application code executed by application software and the application processor executes some libraries while the radio processor executes other libraries and platform specific drivers (e.g., drivers 602).

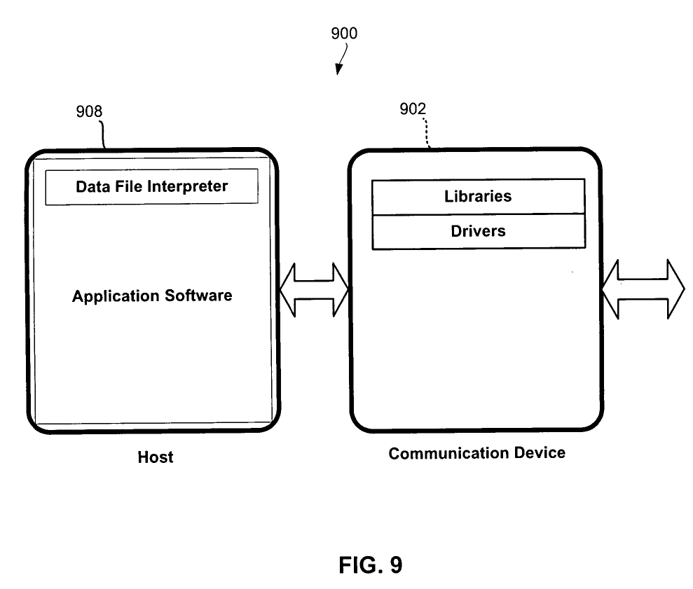

Referring next to FIG. 9, shown is a system 900 in accordance with another embodiment in which interpretation of data files is carried out remote from a communication device 902. As depicted in this embodiment, a host 908 includes a data file interpreter that is realized by software, and the communication device 902 includes portable library and driver APIs that are accessed by the data file interpreter residing within the host 908.

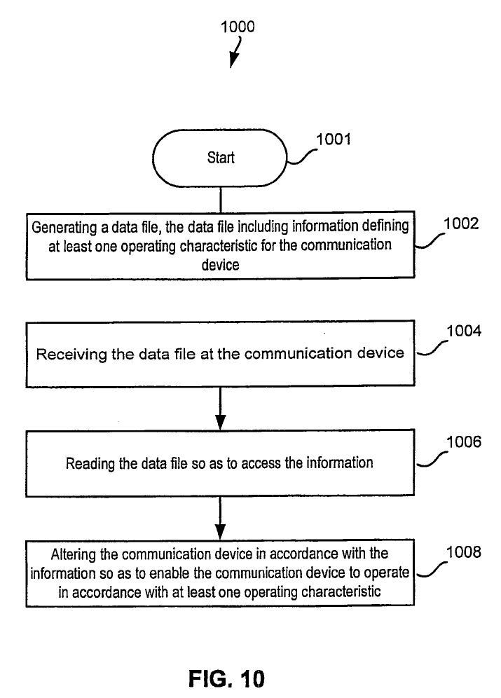

Referring next to FIG. 10, shown is a flowchart depicting steps carried out in accordance with exemplary method 1000 for defining operations of a communication device (e.g., communication devices 102, 702, 802, 902). As shown in FIG. 10, method 1000 starts at block 1001. In block 1002, a data file, which includes information defining at least one operating characteristic (e.g., a communication protocol) for the communication device is generated. In some embodiments, data files are generated at a centralized location that is remote from the communication device and then made available via a network (e.g., the network 103) for download.

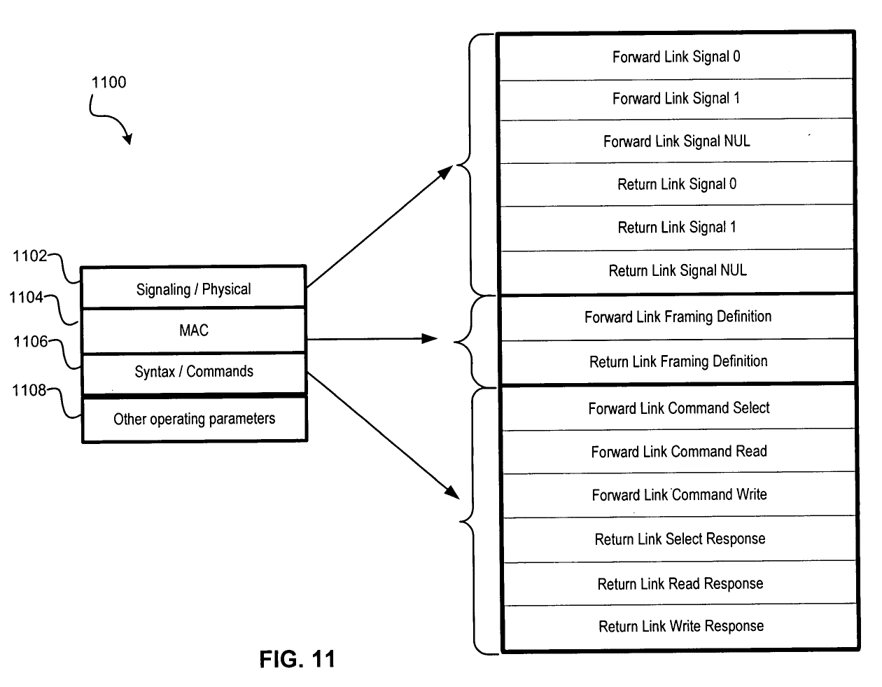

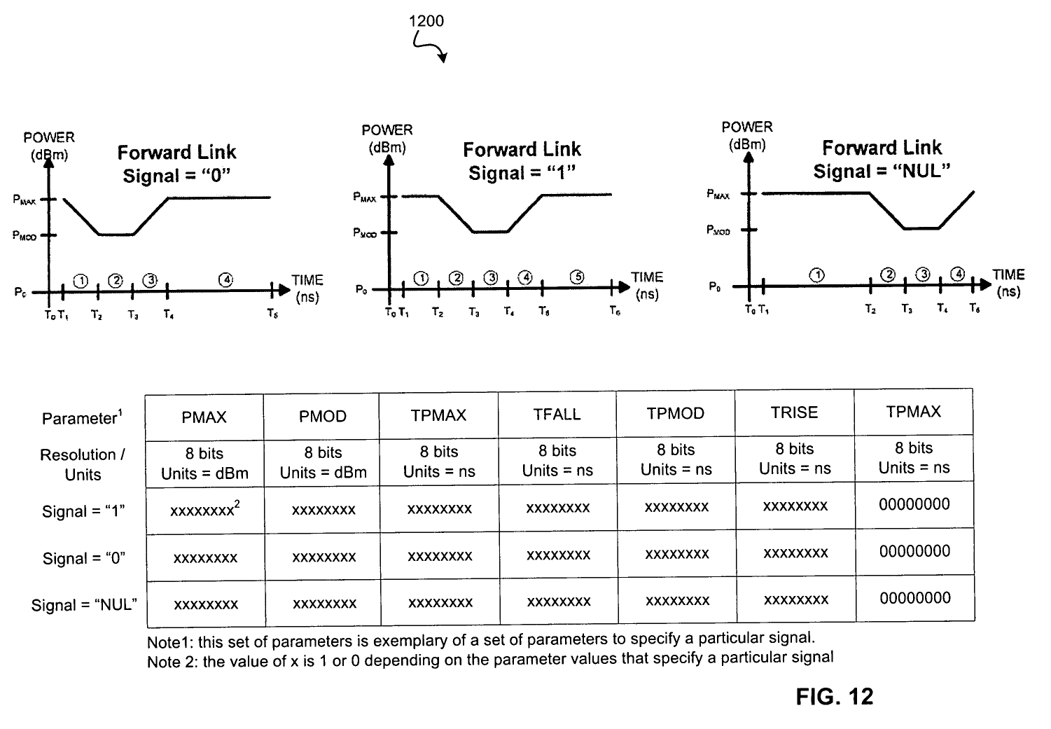

Referring briefly to FIGS. 11 and 12, respectively shown are an exemplary data structure for data files 1100 and a diagram 1200 depicting aspects of physical layer signaling that may be defined by the data file. As shown in FIG. 11, the data file in the exemplary embodiment includes a physical layer segment 1102, a MAC layer segment 1104, a syntax segment 1106 and at least one segment 1108 for defining with data other operating characteristics of a communication device.

As depicted in FIG. 11, the physical layer segment 1102 includes data defining aspects, for both the forward and reverse links, of physical layer signaling. As shown in FIG. 12 for example, a user may customize a signal according to its physical and logical properties (e.g., in terms of relative power levels (e.g., modulation depth)), times associated with each power level and rise/fall times between power levels, and in terms of bit and byte ordering, framing, message syntax and command/response. As discussed further herein, in variations these parameters are described in XML, which makes adding parameters relatively easy (extensible).

Referring again to FIG. 11, the MAC layer segment 1104 includes data defining aspects of framing utilized on the MAC layer on both the forward and return links, and the syntax segment 1106 includes data defining particular commands, which in some embodiments are utilized by a communication device.

In the context of a communication device enabled with RFID tag reading capability, for example, the syntax segment 1106 may include data defining commands for forward link commands associated with selecting, reading and writing to RFID tags, and for defining return link responses corresponding to the forward link select, read and write commands.

The segment 1108 for defining other operating characteristics of the communication device may include, but is not limited to, data for defining power, speed, business logic and utilities, services to provide, services to consume, physical and logical host communication protocols, user interface functionality, default values and runtime values, modes of operation, performance tradeoff algorithms, schedule, event, interrupt and priority handlers and other aspects of the communication device 102.

Referring back to FIG. 10, once a data file is generated, the data file is received by the communication device (Block 1004), and the data file is read so as to access the information which defines one or more operating characteristics (e.g., protocols and/or other operating characteristics) of the communication device (Block 1006). The communication device is then altered in accordance with the information so as to enable the communication device to operate in accordance with the data file (Block 1008).

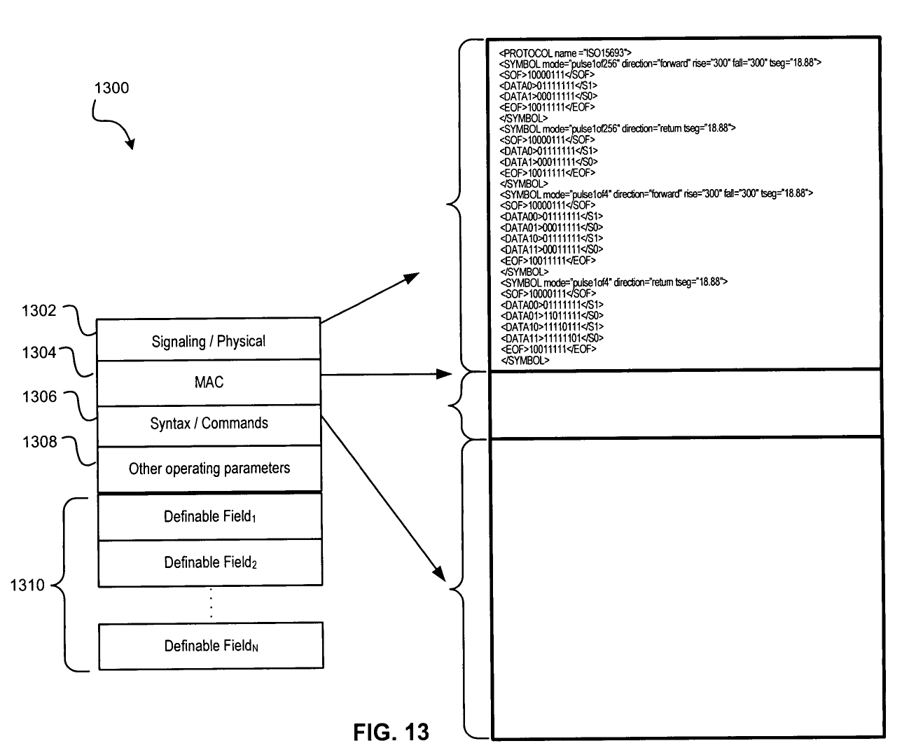

Referring next to FIG. 13, shown is a partial view of an XML file (“Radio XML”) 1300 representation of the general file structure 1100 described with reference to FIG. 11. As shown, the data structure 1300 in this embodiment also includes a physical layer segment 1302, a MAC layer segment 1304, a syntax segment 1306, at least one segment 1308 for defining with data other operating characteristics of a communication device and N definable fields 1310. The data structure 1300 in this embodiment, however, includes data represented in an XML format, which enables end-users to add additional parameters in a relatively easy manner.

Specifically, as shown in FIG. 13, the physical layer segment 1302 includes data, in an exemplary XML format, which defines aspects, for both the forward and reverse links, of physical layer signaling. In addition, the MAC layer segment 1304 includes XML data (not shown) defining aspects of framing utilized on the MAC layer on both the forward and return links, and the syntax segment 1306 includes XML data (not shown) defining particular commands.

Advantageously, the XML data structure 1300 in this embodiment enables a user to optionally add N fields, depicted as the N definable fields 1310, to enable the data file to carry additional information (e.g., to define enhancements to an existing protocol or other operating characteristics) without losing compatibility with the existing protocol and/or previously-defined operating characteristics. As a consequence, a user is able to customize the data structure 1300 to be forward compatible while maintaining backwards compatibility as well.

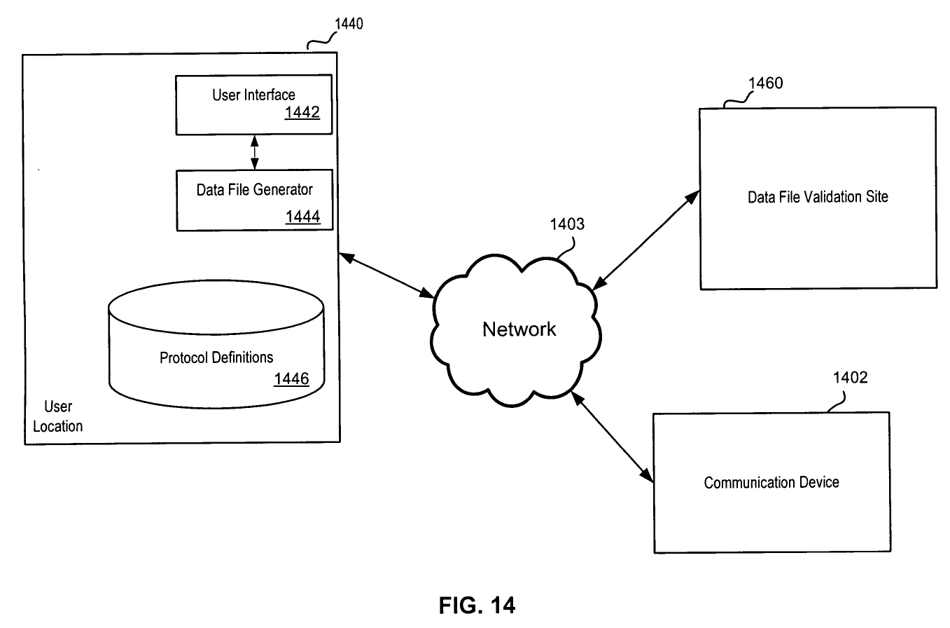

Referring next to FIG. 14, shown is a block diagram of a system for generating and validating data files that define one or more operating characteristics of a communication device 1402. As shown, the system includes a user interface 1442, a file generator 1444 and a data file storage device 1446, which reside at a user location 1440, and as shown, the user location is in communication, via a network 1403, with a data file validation site 1460 and the communication device 1402.

In operation, the user interface 1442 enables a user to convey particular operating characteristics that the user desires to implement in the communication device 1402. In many embodiments for example, the user interface is a graphical user interface, which graphically depicts operating aspects of the communication device that a user may define. In one embodiment for example, the user is provided with a graphical representation of a signal and/or data frame, which the user is able to modify to a desired form.

In response to the user's entries at the user interface, the data file generator 1444 converts the user's entries to one or more data files, which may be tested for validity by sending the data files to the data file validation site 1460. Once received at the data file validation site 1460, the data file(s) is tested to determine whether the data within the data file(s) defines viable operating characteristics for the communication device 1402.

In some embodiments, if the data file(s) include data defining physical and MAC layer protocols for the communication device, the protocols are tested (e.g., with an actual communication device or by simulation) to determine whether the protocols are operable with the communication device 1402. In some embodiments, the protocols are tested to determine the efficacy of the protocols. Once the data file(s) is validated, the user may then propagate the data file(s) to one or more communication devices (e.g., the communication device 1402). In this way, a user may test particular data files without having to take communication devices out of service and without having to test potentially invalid data files on the user's equipment.

Another beneficial aspect of several embodiments of the present invention is the ability to adapt a communication device (e.g., the communication device 102), on demand, to one or more aspects of its environment. For example, a RFID tag may comprise a transceiver. In some embodiments, if the “adaptive” communication device encounters a transceiver (e.g., an RFID transceiver associated with an RFID tag) that utilizes a protocol (e.g., an RFID communication protocol) the communication device does not know, then the communication device and the transceiver in these embodiments initially use a simple or known protocol to “negotiate” to a more complex, practical, and/or useful protocol after the initial exchange is initiated.

In the context of an RFID reader-enabled communication device that is initially encountering an unknown RFID tag, for example, the reader may initially communicate in accordance with ISO15693 standards to establish a basic hand shake with the tag, and then negotiate to a more complex protocol(s) (e.g., a set of ISO15693 extensions or to ISO14443 for a higher data rate). In many embodiments, one or more RFID tags are configured specifically to operate so as to initially communicate with the communication device via a default protocol and then to negotiate to another protocol.

In one variation of these embodiments (i.e., where there is a negotiation from an initial protocol to another protocol), the communication device is instructed by the transceiver to obtain an update (e.g., from a remote server via the network 103) to a known and available protocol. The communication device then updates itself and negotiates to the new protocol properly. In yet other variations, a specialized “negotiation transceiver” (e.g., a negotiation RFID tag) is mixed in with an assortment of transceiver types (e.g., an assortment of RFID tags) and the “negotiation transceiver” tells the communication device how to handle and/or negotiate each transceiver type separately.

In other embodiments, when the communication device encounters a transceiver that utilizes a protocol that the communication device does not know, then the communication device uploads new protocols (e.g., from memory 114 and/or remote storage 101) until the proper working protocol is found for the particular transceiver at hand.

In yet other embodiments, an adaptive communication device assembles pieces of data corresponding to operating parameters until the communication device assembles a combination of data elements that results in a successful communication with the transceiver. As an example, the communication device in accordance with these embodiments may store five data elements corresponding to five types of data encoding, seven data elements corresponding to seven types of modulation schemes and twelve data elements corresponding to twelve data rates, etc. In operation, the communication device combines these parameters in different combinations until a particular combination works to communicate with the transceiver at hand.

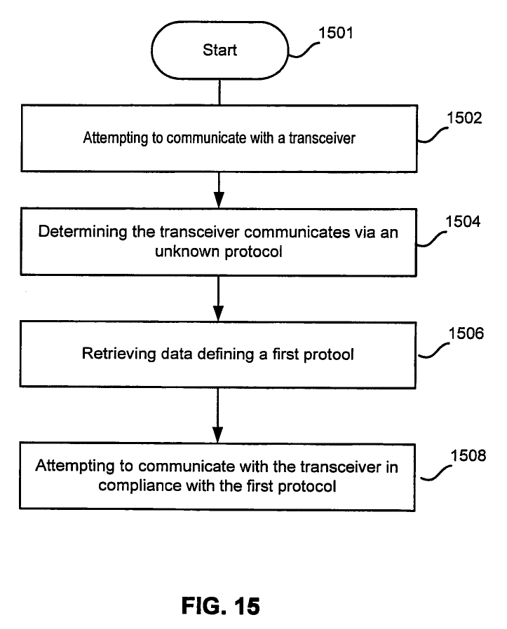

FIG. 15 is a flowchart showing one exemplary embodiment of a method for modifying the operation of a communication device to facilitate communications between the communication device and a transceiver. The method starts at block 1501 and proceeds to block 1502 wherein the communication device attempts to communicate with a transceiver. In block 1504, the communications device determines that the transceiver communicates via an unknown protocol. In block 1506, the communications device retrieves data defining the protocol used by the transceiver. Finally, in block 1508, the communications device attempts to communicate with the transceiver in compliance with the first protocol indicated as being used by the transceiver.

In conclusion, the present invention provides, among other things, a system and method for defining characteristics of a communication device with data, which may be propagated via a data file to one or more data-definable communication devices. Those skilled in the art will readily recognize that numerous variations and substitutions may be made in the invention, its use and its configuration to achieve substantially the same results as achieved by the embodiments described herein. Moreover, it should be recognized that the each of the numerous configuration adjustments that are disclosed herein may be carried out one at a time or simultaneously in various combinations. Accordingly, there is no intention to limit the invention to the disclosed exemplary forms. Many variations, modifications and alternative constructions fall within the scope and spirit of the disclosed invention as expressed in the claims.

1. A method for operating a radio, comprising:
receiving a data file including information defining at least one communication protocol used by the radio;
reading the data file so as to access the information; and modifying operation of the radio in accordance with the information to enable the radio to operate in accordance with the at least one communication protocol.

2. The method of claim 1, wherein the data file includes information defining, at least in part, a physical layer protocol for the radio.

3. The method of claim 1, wherein the data file includes information defining, at least in part, a medium access control protocol for the radio.

4. The method of claim 1, wherein receiving includes receiving the data file as an XML data file.

5. The method of claim 4 further comprising converting the XML data file into a binary data file.

6. The method of claim 1, wherein the information includes information defining at least one communication protocol for an RFID reader operating in connection with the radio, and wherein the protocol defines communications between the RFID reader and one or more RFID tags.

7. The method of claim 6, wherein the information defines, at least in part, a syntax for RFID reader commands.

8. The method of claim 1, wherein the step of modifying operation of the radio includes modifying one or more drivers utilized by the radio.

9. The method of claim 1, wherein the step of receiving includes receiving the data file from a remote server.

10. A wireless communication device, comprising:
an input port configured to receive a data file including information that defines at least one communication protocol for the communication device;
a radio configured to transmit and receive signals; and
a data file interpreter configured to alter operation of the radio in accordance with the at least one communication protocol.

11. The communication device of claim 10 including:
an RFID tag reader coupled to the radio, wherein the tag reader is configured to read tag data received via the radio, and wherein the data file interpreter is configured to alter operation of the RFID tag reader in accordance with information in the data file defining, at least in part, a syntax for RFID reader commands.

12. The communication device of claim 10 further comprising an XML parser coupled to an input line, wherein the XML parser is configured to translate XML data files into binary data files.

13. The communication device of claim 10, wherein the data file includes information defining, at least in part, a physical layer protocol for the radio.

14. The communication device of claim 10, wherein the data file includes information defining, at least in part, a medium access control protocol for the radio.

15. The communication device of claim 10, wherein the data file interpreter includes at least one processor coupled to memory, the memory including instructions to effectuate the at least one communication protocol.

16. The communication device of claim 15, wherein the data file interpreter includes at least two processors, wherein a first of the at least two processors is configured so as to execute instructions to adjust a configuration of the communication device, and wherein a second of the at least two processors is configured to execute instructions to transmit the signals and receive the information.

17. The communication device of claim 10, wherein the data file interpreter includes hardware configured to effectuate the at least one communication protocol.

18. The communication device of claim 17, wherein the hardware includes hardware selected from the group consisting of a field-programmable gate array, a complex programmable logic device, a programmable logic device (PLD), an application-specific integrated circuit (ASIC) and discrete hardware components.

19. The communication device of claim 10 including a memory module coupled to the data file interpreter, wherein the memory module is configured to store at least the data file, and wherein the data file interpreter is configured to retrieve the data file from the memory module.

20. A data structure for a portable data file, the data structure configured to organize information for defining at least one protocol for a communication device, the data structure comprising:
a physical layer segment configured to include data to define physical layer communication characteristics of the communication device; and
a medium access control (MAC) segment configured to include data to define MAC layer communication characteristics of the communication device.

21. The data structure of claim 20 including a syntax segment configured to include data defining a syntax for commands of an RFID tag reader integrated with the communication device.

22. The data structure of claim 20, wherein the physical layer segment is configured to include the data to define physical layer communication characteristics in a first XML format and the MAC segment is configured to include the data to define MAC layer communication characteristics in a second XML format.

23. The data structure of claim 20 including a segment configured to include data to define at least one operating characteristic selected from the group consisting of: power, speed, business logic and utilities, services to provide, services to consume, physical and logical host communication protocols, user interface functionality, default values and runtime values, modes of operation, performance tradeoff algorithms and schedule, event, interrupt and priority handlers.

24. A method for modifying operation of a communication device to facilitate communications between the communication device and a transceiver comprising:
attempting to communicate with the transceiver;
determining that the transceiver communicates via an unknown protocol;
retrieving data defining a first protocol used by the transceiver; and
attempting to communicate with the transceiver in compliance with the first protocol.

25. The method of claim 24, wherein the transceiver includes an RFID tag and the communication device includes an RFID tag reader.

26. The method of claim 24, wherein the step of retrieving the data defining the first protocol includes retrieving the data from a memory residing on the communication device.

27. The method of claim 24, wherein the step of retrieving the data defining the first protocol includes retrieving the data from a remote server via a network.

28. The method of claim 24 further comprising:
carrying out communications between the communication device and the transceiver utilizing the first communication protocol;
negotiating an alternative communication protocol; and
carrying out communications between the communication device and the transceiver utilizing the alternative communication protocol.

29. The method of claim 28, further comprising retrieving data defining the alternative communication protocol from a location selected from the group consisting of: a memory residing on the communication device, a memory external to the communication device and a remote server coupled via a network to the communication device.

30. The method of claim 24, further comprising:
retrieving, in response to the attempt to communicate with the transceiver with the first protocol being unsuccessful, data defining a second communication protocol; and
attempting to communicate with the transceiver utilizing the second communication protocol.

31. The method of claim 30, wherein retrieving the data includes retrieving a plurality of different data elements, wherein each of the different data elements corresponds to one of a plurality of different operating parameters, and wherein different combinations of the different data elements are retrieved until a particular combination of the different data elements defines a protocol utilized by the transceiver.

32. The communication device of claim 11, wherein the RFID tag reader is capable of modifying operation of the radio.
